(19) United States
(12) Patent Application Publication
(10) Pub. No.: US 2012/0006921 A1
(43) Pub. Date: Jan. 12, 2012

(54) Working Vessel Including a Removable Collar and Electric Household Appliance for Culinary Preparation Equipped with Such a Vessel

(75) Inventors: Damien Maunoury, Chalons du Maine (FR); Christophe Lemarie, Martigne-Sur-Mayenne (FR); Michèle Beunache, La Haie Traversaine (FR)

(73) Assignee: SEB S.A., Ecully (FR)

(21) Appl. No.: 13/177,579

(22) Filed: Jul. 7, 2011

(30) Foreign Application Priority Data
Jul. 9, 2010 (FR) 10 55599

(51) Int. Cl. B02C 23/00

(52) U.S. Cl. 241/101.5

(57) ABSTRACT

Working vessel for an electric household appliance for culinary preparation including a removable collar (4) and a casing (3) comprising a bottom end equipped with an opening (30A) surrounded by a sleeve (30) on which said collar (4) can be coupled by turning, said collar (4) comprising a tool holder plate (43) designed to project through said opening (30A), wherein the working vessel includes locking means (6) movable between a locking position, in which the collar (4) and the casing (3) cannot be uncoupled, and an unlocking position in which they can be uncoupled, characterized in that the locking means (6) occupy the locking position when the working vessel is held right side up and the unlocking position when the working vessel is held upside down.

### BACKGROUND OF THE INVENTION

1. Field of the Invention

The present invention relates to the general technical field of electric household appliances for culinary preparation and more particularly relates to a working vessel including a removable collar and a casing comprising a bottom end equipped with a sleeve on which the collar can be coupled by turning.

2. Description of the Prior Art

Such working vessels equipped with a removable collar have the advantage of making the working vessel easier to clean. However, there is a risk that the casing will be accidentally uncoupled from the collar when the user applies force to the handle of the vessel while the latter is disposed on the motor housing. The applicant noted in particular that this involuntary maneuver was more frequently performed on blenders, in which the coupling of the working vessel on the motor housing is achieved by a simple vertical translation movement of the working vessel towards the receiving base of the motor housing. In fact some users try to lock or unlock the working vessel on/from the motor housing by exerting a turning torque on the handle of the vessel, which can cause the casing to uncouple from the removable collar and the contents of the vessel to spill on the motor housing, with a risk of damaging the latter.

U.S. Pat. No. 4,107,791 discloses a way of remedying this disadvantage by integrating a locking device in the removable collar of the working vessel in such a way that the removable collar can only be detached when the working vessel is lifted from the motor housing. To this end, the collar includes a blocking pin that is moved to a locking position when the working vessel rests on the motor housing, in which position the blocking pin impedes the turning of the casing relative to the removable collar and thus prevents the detachment of the removable collar. In this document, however, the path of displacement of the blocking pin is short and the pin therefore moves into an unlocking position when the working vessel is raised slightly from the motor housing. Consequently, if the user raises the working vessel slightly while exerting a torque on the handle when the bottom part is still engaged in the receiving base of the housing, there is still a risk of the casing accidentally uncoupling from the removable collar.

Furthermore, in this aforementioned patent document, the locking pin is not active when the working vessel is placed on a work surface, hence it is possible to bring about an accidental uncoupling of the removable collar by manipulating the vessel when the latter is placed on a work surface.

Also, an object of the present invention is to propose a working vessel equipped with a locking device that is simply and economically manufactured and that achieves a high level of safety in operation by preventing any accidental uncoupling of the removable collar from the casing of the working vessel. In particular, an object of the present invention is to propose a working vessel equipped with a removable collar in which the risk of accidentally uncoupling the removable collar while the working vessel is filled with food is eliminated.

### SUMMARY OF THE INVENTION

To this end, the invention relates to a working vessel for electric household appliances for culinary preparation including a removable collar and a casing comprising a bottom end equipped with an opening surrounded by a sleeve on which the collar can be coupled by turning, said collar comprising a tool holder plate designed to project through the opening, wherein the working vessel includes locking means movable between a locking position, in which the collar and the casing cannot be uncoupled, and an unlocking position in which they can be uncoupled, characterized in that the locking means occupy the locking position when the working vessel is held right side up and the unlocking position when the working vessel is held upside down.

“Working vessel held right side up” is understood to mean that the vessel is disposed in a normal operating position, i.e., with the casing disposed above the collar. Conversely, the vessel shall be considered as held upside down when the collar is disposed above the casing.

According to another characteristic of the invention, the locking means move from the locking position to the unlocking position under the effect of gravity when the working vessel is turned over.

According to another characteristic of the invention, the locking means include at least one blocking pin sliding in a vertical runner between a locking position occupied when the vessel is held right side up and an unlocking position occupied when the vessel is held upside down.

According to still another characteristic of the invention, the sleeve includes ribs that engage, by turning, in a guide groove on the collar for forming a bayonet-type connection.

According to still another characteristic of the invention, in the locking position the blocking pin extends through the guide groove and forms a stop preventing the turning of the envelope in the detachment direction.

The invention also relates to an electric household appliance for culinary preparation including a motor housing equipped with a receiving base, characterized in that it includes a working vessel as previously described comprising a collar that couples on the receiving base.

According to another characteristic of the invention, the coupling of the collar of the working vessel on the receiving base of the motor housing is achieved by a simple movement in vertical translation.

### BRIEF DESCRIPTION OF THE DRAWINGS

The objects, aspects, and advantages of the present invention will emerge more clearly from the following description of a particular embodiment of the invention presented as a non-limiting example, with reference to the appended drawings in which:

FIG. 1 is a perspective view of a culinary preparation appliance according to a particular embodiment of the invention, with the working vessel uncoupled from the motor housing;

FIG. 2 is a perspective view of the working vessel of the appliance of FIG. 1 shown with its cover removed and with the removable collar uncoupled from the casing;

FIG. 3 is a perspective view from below of the removable collar of FIG. 2;

FIG. 4 is a top plan view of the removable collar of FIG. 2;

FIG. 5 is a perspective view of a blocking finger equipping the removable collar of FIG. 2;

FIG. 6 is a cutaway view of the removable collar along line VI-VI of FIG. 4;

FIG. 7 is a perspective view of the removable collar of FIG. 2 held upside down; and

FIGS. 8 and 9 are cutaway views of the working vessel along line VIII-VIII of FIG. 4 when the working vessel is held right side up and upside down, respectively.

### DETAILED DESCRIPTION OF THE INVENTION

Only the elements necessary for the understanding of the invention have been shown. To make the drawings easier to read, the same elements have the same reference numbers from one figure to another.

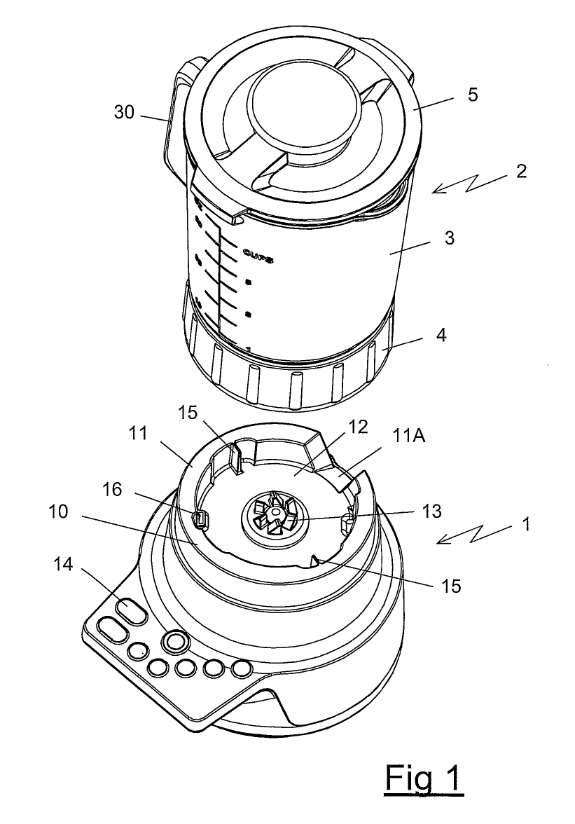

FIG. 1 shows an electric household appliance for culinary preparation of the invention including a motor housing 1 and a working vessel 2 equipped with a lid 5, the working vessel 2 comprising a casing 3 equipped with a handle and a removable collar 4 designed to be positioned on a receiving base 10 of the motor housing 1 by a simple vertical translation movement.

The receiving base 10 includes a peripheral ring 11 cooperating with the collar 4 for ensuring the centering of the working vessel 2 on the motor housing 1 and includes a central cavity 12 receiving a driver 13 driven in rotation by a motor (not shown in the figures) integrated in the motor housing 1, wherein the operation of the motor is controlled by a set of buttons 14 disposed on a control panel.

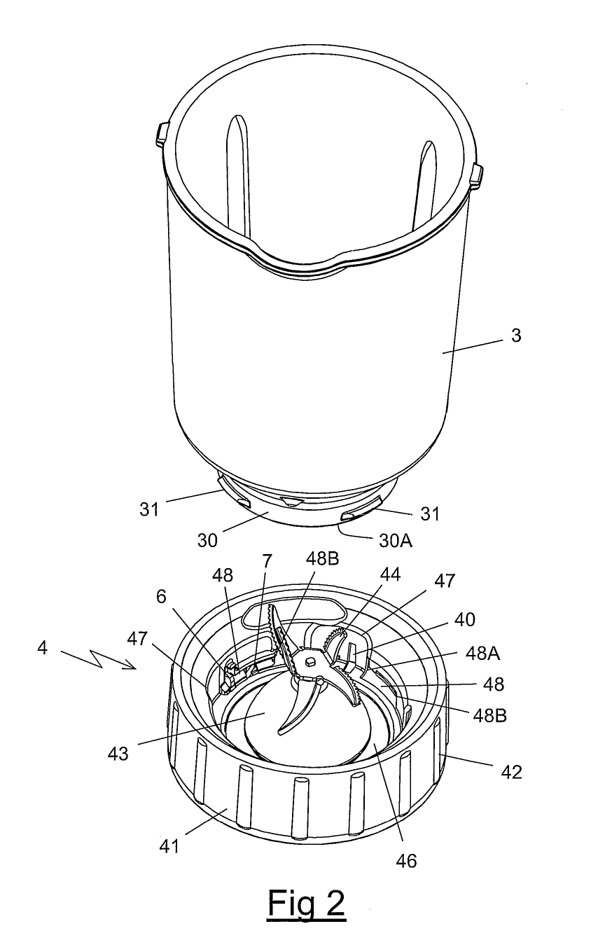

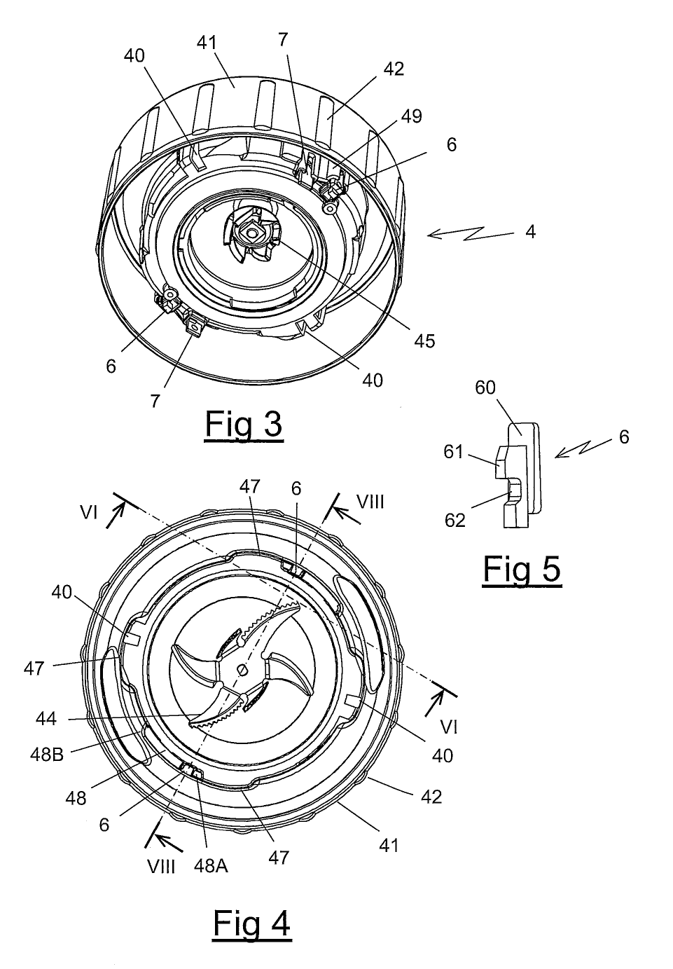

The peripheral ring 11 locally includes a break 11A allowing the automatic drainage of any liquid spilled in the cavity 12, and comprises two failsafe elements 15 disposed at 180° relative to each other and permitting the engagement of the collar 4 of the working vessel 2 on the receiving base 10 in only two possible directions, wherein said mistake-proofing elements 15 engage in grooves 40 of the collar 4 (which are visible in FIGS. 2 and 3) when the working vessel 2 is set on the motor housing 1 by a vertical translation movement.

The motor housing 1 also includes, in a manner known per se, a safety device comprising a safety rod 16 brought into a resting position by a spring and capable of downward vertical displacement for actuating a switch that allows the motor to operate.

According to FIG. 2, the collar 4 includes a peripheral skirt 41 comprising an outer wall equipped with relief elements 42 to make it easier to grasp and comprises an inner wall delimiting a central cavity receiving a tool holder plate 43 comprising a rotary tool 44 fixed on an axle of which the bottom end is connected to a socket 45 (visible in FIG. 3) engaging on the driver 13 of the motor housing 1 when the working vessel 2 is disposed on the receiving base 10.

Preference is given to the casing 3 of the working vessel 2 being made of glass and comprising a bottom end equipped with a sleeve 30 including an opening 30A in which the rotary tool 44 engages when said sleeve 30 is engaged in the central cavity of the collar 4, wherein the collar 4 includes a ring gasket 46 ensuring the sealing of the connection between the bottom end of the sleeve 30 and the collar 4.

The sleeve 30 advantageously comprises four ribs 31 disposed at 90° relative to each other that engage, by an axial movement of the collar 4 relative to the casing 3, in notches 47 formed on the inner wall of the collar 4, wherein the inner wall includes guide grooves 48 comprising an open end 48A opening laterally on the notches 47 in such a way that the ribs 31 can engage in the guide grooves 48 by turning the casing 3 clockwise when the bottom end of the sleeve 30 is resting against the gasket 46, thus achieving a bayonet-type connection.

Preference is given to the guide grooves 48 having a circumferential length slightly greater than the length of the ribs 31 and having a closed end forming a stop 48B impeding the turning of the casing 3 when the latter is correctly coupled on the collar.

More particularly according to the invention, the working vessel 2 includes locking means 6 preventing the uncoupling of the collar when the vessel 2 is held right side up.

According to FIGS. 3 through 6, these locking means consist of a blocking pin 6 slide-mounted in a vertical runner 49 disposed at the level of the open end 48A of at least one of the guide grooves 48, and preferably of two guide grooves 48 oppositely disposed to each other. Each blocking pin 6 advantageously includes a guide plate 60 supporting a head 61 projecting through a vertical groove 49A formed in the inner wall of the collar 4, the head 61 surmounting a cutout 62 shaped similarly to the cross-section of the guide groove 48.

The blocking pins 6 are movable between a locking position, into which they slide by gravity when the collar 4 is positioned right side up, and an unlocking position into which they slide by gravity when the collar 4 is turned upside down.

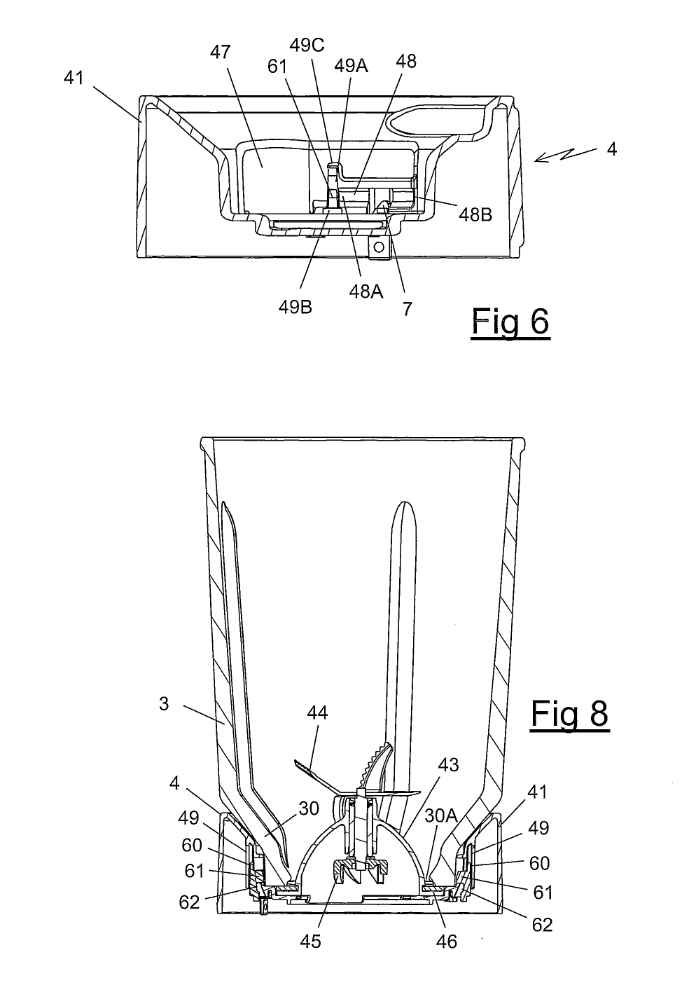

In the locking position, notably illustrated in FIGS. 2 and 6, the bottom edge of the head 61 rests against a bottom stop 49B on the inner wall of the collar 4 in such a way that the blocking pin 6 is immobilized in a position in which the head 61 projects through the guide groove 48.

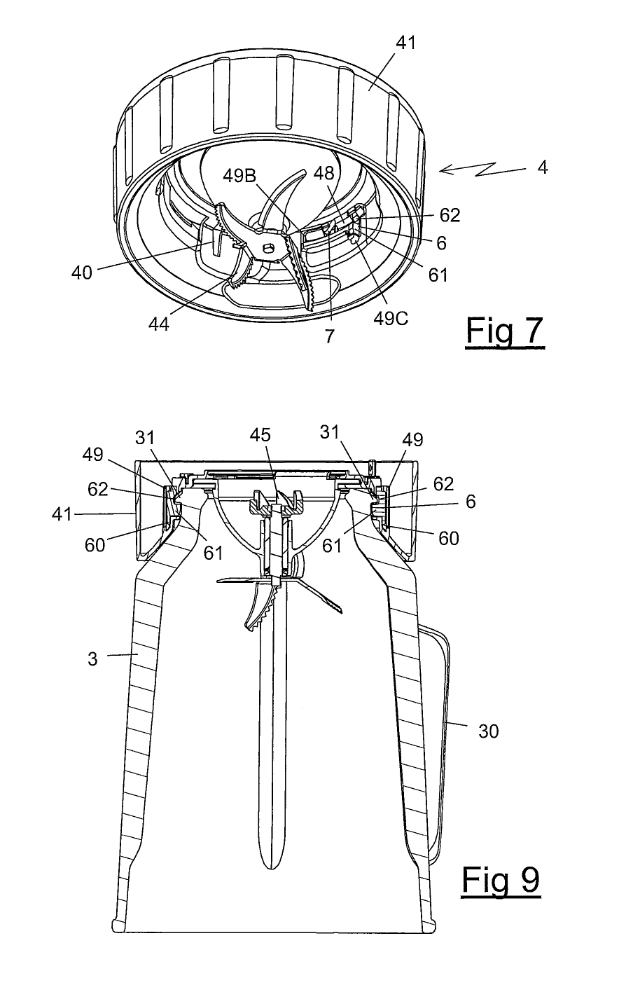

In the unlocking position illustrated in FIG. 7, the top edge of the head 61 rests on a top stop 49C on the inner wall of the collar 4 in such a way that the blocking pin 6 is immobilized in a position in which the cutout 62 is level with the guide groove 48.

In an advantageous manner, the collar 4 also includes a device for detecting the presence of the casing and consisting of a safety finger 7 passing perpendicularly through the guide grooves 48 receiving the blocking pins 6. When the casing 3 is coupled to the collar 4, the safety finger 7 is immobilized in a low position (illustrated in FIG. 7) by the presence of the rib 31 of the sleeve 30 above the safety finger 7 and actuates the safety rod 16 of the motor housing 1 when the collar 4 is disposed on said motor housing 1. Conversely, when the collar 4 is disposed on the motor housing 1 without the casing being coupled to the collar 4, the safety finger 7 slides into a high position without actuating the safety rod 16.

The functioning of the locking device will now be described with reference to FIGS. 8 and 9.

FIG. 8 illustrates the working vessel 2 with the casing 3 coupled to the collar 4 when the working vessel 2 is positioned right side up. In this position, the blocking pins 6 are brought by gravity into the locking position, in which the head 61 of the blocking pin 6 projects from the open end 48A of the guide groove 48 in such a way that the detachment of the casing 3 is rendered impossible, the rib 31 of the sleeve 30 coming in abutment against the head 61 of the blocking pin 6 when a rotation in the loosening direction is exerted on the casing 3.

In order to be able to uncouple the removable collar 4 from the casing 3 of the working vessel 2, the user must hold the working vessel 2 upside down in such a way that the blocking fingers 6 are brought by gravity into the unlocking position in which the cutout 62 is positioned relative to the guide groove 48 in such a way that the rib 31 of the sleeve 30 can be introduced in the notches 47 by turning the casing 3 in the loosening direction, as illustrated in FIG. 9.

Hence the working vessel thus configured exhibits a high level of operational safety by only allowing the detachment of the removable collar when the working vessel is held upside down. Any accidental uncoupling of the collar is thus avoided, particularly during the phases of positioning the working vessel on and removing it from the motor housing, or while manipulating the vessel on a work surface.

Obviously the invention is in no way limited to the embodiment described and illustrated herein, which was given merely as an example. Modifications are still possible, particularly in terms of the constitution of various elements or by substitution of equivalent techniques, without exceeding the scope of protection of the invention in any way.

1. Working vessel for an electric household appliance for culinary preparation including a removable collar and a casing comprising a bottom end equipped with an opening surrounded by a sleeve on which said collar can be coupled by turning, said collar comprising a tool holder plate designed to pass through said opening, wherein the working vessel includes locking means movable between a locking position, in which the collar and the casing cannot be uncoupled, and an unlocking position in which they can be uncoupled, wherein the locking means occupy the locking position when the working vessel is held right side up and the unlocking position when the working vessel is held upside down.

2. Working vessel as in claim 1, wherein said locking means move from the locking position to the unlocking position under the effect of gravity when the working vessel is turned over.

3. Working vessel as in claim 2, wherein said locking means include at least one blocking pin sliding in a vertical runner between a locking position occupied when the working vessel is held right side up and an unlocking position occupied when the vessel is held upside down.

4. Working vessel as in claim 3, wherein the sleeve includes ribs engaging, by turning, in a guide groove on said collar for forming a bayonet-type connection.

5. Working vessel as in claim 3, wherein the blocking pin in the locking position extends through the guide groove and constitutes a stop impeding the turning of the casing in the direction of detachment.

6. Electric household appliance for culinary preparation including a motor housing equipped with a receiving base, including a vessel as in claim 1, further comprising a collar that is coupled on said receiving base.

7. Electric household appliance for culinary preparation as in claim 6, wherein the coupling of the collar of the working vessel on the receiving base of the motor housing is achieved by a movement in vertical translation.
